(19) United States
(12) Patent Application Publication
(10) Pub. No.: US 2003/0235689 A1
(43) Pub. Date: Dec. 25, 2003

(54) Ultrafine hexagonal ferrite particles

(76) Inventors: William Rafaniello, Midland, MI (US); Pete C. LeBaron, Midland, MI (US); Melinda H. Keefe, Midland, MI (US); Promod Kumar, Midland, MI (US); Eric J. Swedburg, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/447,525

(22) Filed: May 29, 2003

Related U.S. Application Data
(60) Provisional application No. 60/384,354, filed on May 29, 2002.

(51) Int. Cl. H01F 1/00; B05D 7/00

(52) U.S. Cl. 428/403; 252/62.63; 252/62.62; 252/62.59; 427/212

(57) ABSTRACT

The present invention is directed to hexagonal ferrite particles coated with a dispersant and having an exceptionally uniform particle size distribution that makes them particularly useful in the manufacture of high density magnetic tape.

### CROSS-REFERENCE STATEMENT

This application claims the benefit of U.S. Provisional application No. 60/384,354 filed May 29, 2002.

### FIELD OF THE INVENTION

The present invention relates to ultrafine hexagonal ferrite particles, which are suitable in the preparation of high density magnetic recording media.

### BACKGROUND OF THE INVENTION

Small-sized computers such as mini computers and personal computers have been widely employed in business for some time. Due to storage size limitations in the computers, data are periodically downloaded to external storage devices. Typically, magnetic recording media, for example, computer tapes or discs have been used to as external storage devices to store and retrieve the downloaded data.

In recent years, the use of the Internet and email has intensified the need for higher storage density in magnetic recording media for back-up storage. Estimates have placed the increase in storage density requirements of commercial magnetic recording media at 60 percent per year. A typical magnetic tape comprises a flexible plastic web, i.e., support, and a magnetic recording layer coated on the support in the same manner as in a conventional audio tape or video tape. The magnetic recording layer typically comprises a ferromagnetic powder and a binder. The back-up tape is usually encased in a cassette. Since the size of the cassette for encasing the magnetic tape cannot be easily enlarged, the thickness of the support and magnetic coating layers have been reduced in order to accommodate the need for increased storage capacity. In addition, increased data storage capacity of a magnetic recording tape has been attained by decreasing the size of the ferromagnetic powder particles.

Magnetic recording tapes are used in a variety of formats for digital signal recording systems. For example, magnetic tapes corresponding to a DLTtape™ format, Magstar 3490™ and LTO Ultrium™ format are commercially available (DLTtape is a trademark of Quantum Corp., Magstar 3490™ is a trademark of IBM and Linear Tape-Open, LTO and Ultrium are trademarks of Hewlett-Packard, IBM and Seagate). In such systems, the magnetic tape may comprise, on one side of a support, a magnetic layer of a single layer structure having a comparatively thick layer, typically from 2.0 to 3.0 micrometers, containing a ferromagnetic powder, a binder and an abrasive, and a back coating layer on the other side of the support for purposes of preventing winding disarrangement and maintaining good running durability. As an alternative to the single layer structure, the magnetic tape may comprise, on one side of the support, a nonmagnetic layer containing an inorganic powder dispersed in a binder (also referred to herein as a “lower layer” or “first layer”) and a magnetic layer containing a ferromagnetic powder dispersed in a binder (also referred to herein as an “upper layer” or “second layer”) over the first layer. The other side of the support may optionally comprise a back coating layer. In the multiple layer configuration, the magnetic layer typically has a thickness of 1.0 μm or less.

Despite the advances in magnetic recording media to achieve higher storage density, further advances in increasing recording density are desired. In addition, improvements in the reliability of data storage and performance, such as stable recording and readout of data after multiple uses are desired.

### SUMMARY OF THE INVENTION

The present invention addresses a need in the art by providing a composition comprising hexagonal ferrite particles coated with a dispersant, which particles have an average particle size of from about 10 nm to 50 nm wherein less than about 5 percent of the particles have a particle size below about 5 nm and less than about 5 percent of the particles have a particle size above about 70 nm.

In a second aspect, the present invention is a method for preparing coated metal oxide nanoparticles comprising the steps of a) dissolving a metal-containing compound into a solvent to form a solution; b) introducing the solution into a heated zone for such a time and at such a temperature to make a nanocrystalline metal oxide; c) milling the nanocrystalline oxide in the presence of a dispersant and a dispersion medium to form the coated metal oxide nanoparticles.

In a third aspect the present invention is method for preparing coated substituted hexagonal ferrite nanoparticles comprising the steps of a) dissolving salts of iron III, barium, cobalt, titanium, and chromium into water and at least a 40 percent stoichiometric excess of citric acid with respect to the salts to form a solution; b) introducing the solution within an aerosol into a heated furnace to make nanocrystalline hexagonal ferrite aggregates; and c) milling the aggregate in the presence of a phosphate ester and cyclohexanone to form the coated substituted hexagonal ferrite nanoparticles.

By virtue of the present invention, it is now possible to provide magnetic recording media which have high recording density, e.g., typically greater than about 0.1 gigabites per square inch (0.016 gigabites/cm2), as well as other desirable characteristics such as, for example, high resolution, low noise, high signal to noise ratio and high durability. Accordingly, the ultrafine hexagonal ferrite particles of the present invention are particularly suitable for use in computer back-up tapes or discs.

### DETAILED DESCRIPTION OF THE INVENTION

As used herein, the term “hexagonal ferrite particles” means ferrite particles with a hexagonal crystal structure. Thus, the term hexagonal ferrite particles used with reference to the crystal structure of the ferrite material and not to the physical shape of the particles. The hexagonal ferrite particles suitable for use in accordance with the present invention have an average particle size of from about 10, preferably from about 15 nm, to about 50, preferably to about 40, and more preferably to about 35 nm, wherein less than about 5 percent, by number, of the particles have a particle size below about 5 nm and less than about 5 percent of the particles have a particle size above about 70 nm. As used herein, the term “average particle size” means the average diameter (also referred to in the art as “effective diameter”) determined by the direct measure of the long and short dimension of the particles from scanning or transmission electron photomicrographs. Then, assuming that the particles approximate a rectangular shape, the area of the rectangle is calculated. The effective diameter of each particle then is the diameter of a circle that has the equivalent area as calculated for the rectangle.

When reproduction is conducted using a magneto resistance head, in particular, for increasing track density, it is desirable to reduce noise. Accordingly, the average diameter is preferably not larger than 40 nanometers and not smaller than 10 nm, because if the particle diameter is smaller than 10 nm, magnetization stabilization typically decreases due to thermal fluctuations.

Preferably, the hexagonal ferrite particles of the present invention have a coercive force or coercivity (He) of at least 1500, more preferably at least 1800, and most preferably at least 2000 oersteds (Oe), and preferably not more than 6000, more preferably not more than 3500, and most preferably not more than 2500 Oe.

A preferred method for preparing hexagonal ferrite particles of the present invention, or coated metal oxide nanoparticles is general, is spray pyrolysis. In a first step, a metal-containing compound is dissolved in a solvent to form a solution. Examples of metal-containing compounds include soluble metal salts, metal alkoxides, organometallics and combinations thereof. The metal-containing compound is more preferably a blend of soluble salts of iron III and barium and a most preferred metal-containing compound is a blend of soluble salts of iron III, barium, cobalt, chromium, and titanium.

The solvent is preferably water-based and it is preferable to dissolve the metal-containing compound in water in the presence of a stoichiometric excess of citric acid, more preferably at least a 40 percent excess of citric acid with respect to the metal-containing compound.

In a second step, the solution is introduced through a heated zone, preferably within an aerosal into a hot furnace, for such a time and at such a temperature to convert the compound to a nanocrystalline metal oxide. The nanocrystalline oxide is preferably a mixed metal oxide that is ferromagnetic, piezoelectric, or ion-conducting, or a perovskite material. More preferably the nanocrystalline oxide comprises hexagonal ferrite crystallites in the size range desired.

In a third step, the nanocrystalline metal oxide is then advantageously milled in the presence of a dispersant to form the coated metal oxide nanoparticles, preferably coated hexagonal ferrite nanoparticles. Using this solution to generate an aerosol enables the formation of hollow porous-walled micron sized spheres of aggregated hexagonal ferrite crystals. The ultimate crystal size can be advantageously controlled by decreasing the solution concentration and/or adding fugitive components, and/or adding substituted atoms (such as cobalt, chromium, and titanium) into the ferrite structure. Additionally, the method provides aggregates with enhanced friability, which facilitates the attainment of the desired particle size distribution. The size distribution can be further controlled, if desired, by ultrafiltration.

The milling of the aggregates is carried out in the presence of grinding media, a dispersant, and a dispersion medium to form coated discrete nano-sized particles. The grinding media is typically ultrafine (˜100 μm diameter) organic or ceramic spheres.

Examples of grinding media include, but are not restricted to yttria-stabilized zirconia, alumina, and polystyrene.

Examples of suitable dispersants include long chain carboxylic acids including stearic acid, oleic acid, lauric acid; amines included aminated propylene oxides (commercially available as Jeffamines™, a trademark of Huntsman Chemical); quaternary ammonium salts; acrylic acids including polyacrylic acids; acrylate salts; methacrylic acids including polymethacrylic acids; methacrylate salts including salts of polymethacrylic acid; polycaprolactams; and phosphate esters.

The amount of the dispersant is typically from 0.1 to 10 percent by weight based on the amount of the hexagonal ferrite particles and the dispersant. The selection of the preferred dispersant is dependent on the selection of the dispersion medium. If the dispersion medium is aqueous, that is, where water is the primary component, the preferred dispersant is a salt of a polymethacrylic acid. Where the dispersion medium is organic, for example, cyclohexanone, tetrahydrofuran, a glycol, chloroform, methylene chloride, carbon tetrachloride, dichlorobenzene, xylene, toluene, mesitylene, etc., the preferred dispersant is a phosphate ester. Commercially available phosphate esters include Emphos™ phosphate esters (Akzo Nobel). A preferred organic dispersion medium is cyclohexanone.

Preferably, the hexagonal ferrite compositions of the present invention contain at least about 90 wt percent, more preferably at least about 95 wt percent and most preferably at least about 99 wt percent hexagonal ferrite, with the balance comprising synthesis by products such as, for example, monoferrite and iron oxide. This characteristic is referred to in the art as phase purity. The phase purity can be measured, for example, by x-ray diffraction, the details of which are known to those skilled in the art.

Examples of hexagonal ferrites which can be used according to the present invention include substitution products of barium ferrite, strontium ferrite, lead ferrite, and calcium ferrite, with barium ferrite being preferred. The ferromagnetic hexagonal ferrite powders advantageously include a small amount of an iron substitute, namely, atoms of one or more dopants, preferably transmission metals, that replace atoms of iron. Particularly preferred iron substitutes include Co, Ti, and Cr and combinations thereof. The formula for the iron/iron substitute is Fe12-xMx, where M represents one or more substitutes and x represents the total amount of Fe atoms that are being substituted. Preferably, x is at least 0.1, more preferably at least 0.5, and most preferably at least 1.0, and preferably not greater than 2.0. A formula for a particularly preferred iron/iron substitute is Fe12-xCoaTibCrc, where a+b+c=x.

The coated hexagonal ferrite particles of the present invention can be combined with a binder to create a magnetic medium with desired properties. The binder is a polymer that is compatible with the coated hexagonal ferrite particles. Examples of suitable polymers include thermoplastic resins, thermosetting resins, reactive resins, and mixtures thereof. As used herein the term “compatible” means an affinity or attraction between the coated hexagonal ferrite particles and binder. The combination of the binder and the coated hexagonal ferrite particles can be used to make a high density magnetic tape.

The invention is hereafter described with respect to the examples which are not intended to limit the scope of the claims which follow.

### EXAMPLE 1

### Preparation of Coated Hexagonal Ferrite Particles

Citrate-based precursor mixtures of 0.02M Ba+2 and 0.24M Fe+3ions were prepared by the following method: Ba(NO3)2 (5.22 g, 0.02 moles) was dissolved in deionized (DI) H2O (400 mL) under mild heating. To this solution Fe(NO3)3 (96.96 g, 0.24 moles) was added followed by the addition of a citric acid solution (48.667 g/200 ml, 1.26M). The pH of this mixture was then adjusted to 7.0 using NH4OH. Lastly, the solution was brought up to 1 L with DI H2O.

The particles were synthesized by pyrolysis of an aerosol of the citrate-based precursor. The aerosol pyrolysis equipment consisted of a aerosol generator, a carrier gas flow, quartz tube furnace, and a collection system. The precursor solution was metered into the system via a syringe pump operating at 0.4 mL/min. The solution flowed into a sonicator vessel (300 mL) housed in an ultrasonic apparatus (Model V5100, VICKS® Ultrasonic Humidifier, Kaz, Inc., Hudson, N.Y.) that was continuously flushed with air at 6L/min. The generated aerosol mist flowed through a 4-inch diameter (10-cm) by 4-foot (1.3-m) long fused quartz tube furnace at 950° C. where evaporation of the water and combustion of the citrate occurred followed by nucleation and crystallization of the barium ferrite particles. Pure product was then collected after condensing on the cool surfaces of the exit. X-ray diffraction analysis indicated that the resulting product was >95 percent barium ferrite. Using high resolution electron microscopy, it was determined that this product was composed of micron sized hollow spheres having a wall structure consisting of aggregated ˜30-nm barium ferrite primary crystals.

Milling of these hollow spheres to nanosized particles was achieved using 100 μm or 30 μm YTZ® milling media, available from TOSOH Ceramics Division, Bound Brook, N.J. The formed barium ferrite aggregates (13.79 g) were suspended in 93 mL of a 1 percent (by weight) Daxad 30 (Hampshire Chemical, sodium polymethacrylate) aqueous solution. The mixture was then agitated until the particles were completely dispersed. Dry milling media was added to the 200-mL cavity mill while the inner shaft was continually turned until ˜90 percent of the available free space was filled with media. The barium ferrite containing suspension was added to the mill. The mill agitator speed was held constant at 800 rpm and the samples were milled for 5 minutes. The average particle size as determined by hydrodynamic chromotography was 26 nm and closely matches average particle size determinations from x-ray diffraction crystallite calculations and estimates from electron photomicrographs. The magnetic coercivity of the powder determined at room temperature using a Quantum Design MPMS SQUID (superconducting quantum interference device) magnetometer was 2700 Oerstads (Oe).

### EXAMPLE 2

### Preparation of Substituted Coated Hexagonal Ferrite Particles

Ba(NO3)2 (2.61 g) was added with stirring to a glass beaker containing 400 mL of distilled water. Fe(NO3)3·9H2O (43.03 g) was added followed by Co(NO3)2·6H2O) (1.31 g), Cr(NO3)3·9H2O (1.80 g) and titanium (IV) bis(ammoniumlactato) dihydroxide (2.65 g, 50 wt. percent solution in water). Citric acid (37.47 g, 50 percent excess over stoichiometric) was then added to the metal salt solution. After all of the additives were dissolved, the solution was neutralized (pH of 7) by adding NH4OH (29 percent) solution dropwise. Additional distilled water was added to bring the final solution volume to 500 mL. The metal citrate solution was fed into a glass reservoir where it was nebulized using an ultrasonic transducer. The formed aerosol was carried through a 6-cm diameter quartz tube furnace (140 cm long) that was set at ˜975° C. using air flowing at 6 lpm (liters per minute). The hexagonal ferrite powder was collected in the cool zones at the exit of the furnace. The rate of powder formation was ˜0.4 g/hr. The largely phase pure substituted ferrite powder was found to contain <2 percent Fe2O3. The coercivity of the formed substituted ferrite powder was found to be 2650 Oe.

The stirred media mill, having an internal volume of 155 mL was first filled with 100 mL of milling media (100-μm diameter), which was added while manually engaging the rotor. The combination of solvent, cyclohexanone, (72 mL), dispersant (˜0.7 g) and substituted ferrite powder (5 g) was then added, again while the mill was turning. Finally, an additional 35 mL of media were added. The mill was operated at 900 rpm in two, 3-minute segments for a total of 6 minutes. The mill contents were emptied onto a sieve (75-μm screen) to capture the media. To reclaim the substituted ferrite powder from the slurry, cyclohexanone was removed in vacuo. The particle size distribution of the milled powder was determined by direct particle counting of electron micrographs. The mean particle diameter was determined to be 19.1 nm. The complete distribution of the 343 particles counted is shown below. The magnetic coercivity of the milled powder was found to be 2500 Oe.

TABLE
Particle Size Distribution

| Particle Range (nm) | Number of Particles in the Range |
|---|---|
| <5 | 1 |
| 5-10 | 61 |
| 10-15 | 95 |
| 15-20 | 65 |
| 20-25 | 33 |
| 25-30 | 26 |
| 30-35 | 10 |
| 35-40 | 13 |
| 40-45 | 5 |
| 45-50 | 7 |
| 50-55 | 4 |
| 55-60 | 6 |
| 60-65 | 4 |
| 65-70 | 5 |
| 70-75 | 2 |
| 75-80 | 4 |
| >80 | 2 |

In the claims:

1. A composition comprising hexagonal ferrite particles coated with a dispersant, which particles have an average particle size of from about 10 nm to about 50 nm wherein less than about 5 percent of the particles have a particle size below about 5 nm and less than about 5 percent of the particles have a particle size above about 70 nm.

2. The composition of claim 1 wherein said particles have an average particle size of from about 15 nm to 40 nm and wherein the particles have a coercivity in the range of from about 1500 Oe to about 6000 Oe.

3. The composition of claim 2 wherein said particles have an average particle size of from about 15 nm to 35 nm wherein the particles have a coercivity in the range of from about 2000 Oe to 2500 Oe.

4. The composition of claim 2 wherein the ferrite contains iron III atoms and atoms of an iron substitute.

5. The composition of claim 3 wherein the iron substitute is selected from the group consisting of Ti, Co, and Cr.

6. The composition of claim 5 wherein the ratio of the iron III atoms to the atoms of the iron substitute is from about 11.9:0.1 to about 10:2 and the iron substitute includes Ti, Co, and Cr.

7. The composition of claim 1 wherein the dispersant is selected from the group consisting of stearic acid, oleic acid, lauric, aminated propylene oxides, acrylate salts, polyacrylic acids, polymethacrylic acids, salts of polymethacrylic acid, quaternary ammonium salts, and phosphate esters.

8. The composition of claim 6 wherein the dispersant includes a phosphate ester.

9. The composition of claim 6 wherein the dispersant includes a salt of a polymethacrylic acid.

10. A method for preparing coated metal oxide nanoparticles comprising the steps of a) dissolving a metal-containing compound into a solvent to form a solution; b) introducing the solution into a heated zone for such a time and at such a temperature to make a nanocrystalline metal oxide; c) milling the nanocrystalline oxide in the presence of a dispersant and a dispersion medium to form the coated metal oxide nanoparticles.

11. The method of claim 10 wherein the nanocrystalline oxide is a mixed metal oxide selected from the group consisting of ferromagnetic materials, piezoelectric materials, perovskite materials, and ion-conducting materials.

12. The method of claim 10 wherein the metal-containing compound is selected from the group consisting of soluble metal salts, metal alkoxides, and organometallics.

13. The method of claim 10 wherein the solution is introduced within an aerosol into a heated furnace.

14. The method of claim 10 wherein the dispersion medium is aqueous based and dispersant is a salt of a polymethacrylic acid.

15. The method of claim 10 wherein the dispersion medium is organic and the dispersant is a phosphate ester.

16. The method of claim 10 wherein the metal-containing compound is dissolved in the solvent in the presence of a stoichiometric excess of citric acid with respect to the metal-containing compound.

17. The method of claim 10 which in step (b) forms a friable product having aggregated nanocrystals in a hollow, single crystal thick walled structure.

18. The method of claim 10 wherein the coated metal oxide nanoparticles have an average particle size of from about 10 nm to 50 nm, wherein less than about 5 percent of the particles have a particle size below about 5 nm and less than about 5 percent of the particles have a particle size above about 70 nm.

19. The method of claim 18, wherein the size distribution of the coated metal oxide nanoparticles is narrowed by ultrafiltration.

20. A method for preparing coated substituted hexagonal ferrite nanoparticles comprising the steps of a) dissolving salts of iron III, barium, cobalt, titanium, and chromium into water and at least a 40 percent stoichiometric excess of citric acid with respect to the salts to form a solution; b) introducing the solution within an aerosol into a heated furnace to make nanocrystalline hexagonal ferrite aggregates; and c) milling the aggregate in the presence of a phosphate ester and cyclohexanone to form the coated substituted hexagonal ferrite nanoparticles.
